(19) United States
(12) Patent Application Publication
(10) Pub. No.: US 2009/0153003 A1
(43) Pub. Date: Jun. 18, 2009

(54) METHOD AND APPARATUS FOR ENGAGING A WASHTUB WITH A BASE IN A WASHING APPLIANCE

(75) Inventors: John Helgesen, Rock Hill, SC (US); Torkel Kristensson, Zirndorf (DE); Daniel Clay White, Pink Hill, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Electrolux Home Products, Inc.

(21) Appl. No.: 12/018,960

(22) Filed: Jan. 24, 2008

Related U.S. Application Data
(60) Provisional application No. 60/888,675, filed on Feb. 7, 2007.

(51) Int. Cl. D06F 39/12; B29C 65/00; A47L 15/42

(52) U.S. Cl. 312/228; 156/60

(57) ABSTRACT

A washing appliance and associated method for assembling a washing appliance, such as a dishwashing machine, is provided. The washing appliance includes a tub having a wall member and defining an access opening. The washing appliance further includes a base member configured to receive the tub. Each of the base member and the wall member of the tub include complementary engageable surfaces. An adhesive substance is also disposed between the complementary engageable surfaces of the tub and base member so as to secure the tub to the base member.

### CROSS-REFERENCE TO RELATED APPLICATIONS

This application claims the benefit of U.S. Provisional Application No. 60/888,675, filed Feb. 7, 2007, the contents of which are incorporated herein by reference.

### BACKGROUND OF THE INVENTION

1. Field of the Invention

Various embodiments of the present invention are directed to a method and apparatus for engaging a washtub with a base in a washing appliance, such as a dishwasher.

2. Description of Related Art

Washing appliances, such as dishwashers, include a wash tub for containing dishware or other items to be washed. However, the tub must also include surrounding structure and components to form an overall appliance assembly that is structurally sound, installable, and capable of being insulated for sound-deadening. Components of the appliance, such as the various controls, valves, and pumps, for example, are mounted outside the tub, but within the overall structure of the appliance. Accordingly, in many washing appliances, the tub is typically supported within the appliance assembly by a base component which must be fastened to the tub in order to keep the appliance assembly together. Thus, many of the components of the appliance may be mounted in the base and, in many cases, under the tub.

Many conventional washing appliances include holes defined by the tub for receiving fasteners for fastening the various components (including, in some cases, a base component) to the tub. However, in forming a washing appliance assembly, it is generally preferable to minimize and/or eliminate any holes extending through the walls of the tub so as to reduce and/or minimize the risk of water leakage from the tub during use of the washing appliance. Further, since the tub is often formed by a molding process (when forming polymer tubs, for example) or a stamping process (when forming metallic tubs, for example), ears or flanges for attaching components to the tub often cannot be readily formed on the exterior of the tub itself.

Thus, there exists a need for an apparatus and method whereby a wash tub is engaged with a base component in a washing appliance without defining potentially leak-producing apertures in the washtub. There further exists a need for such an apparatus and method that can be implemented with wash tubs stamped and/or formed from a variety of materials, and that also allows for the formation of a substantially complete and structurally-sound washing appliance structure, without further compromising a substantially fluid-tight aspect of the tub.

### BRIEF SUMMARY OF THE INVENTION

Certain embodiments of the present invention satisfy the above and other needs and provide other advantages as described below. Embodiments of the present invention may include a washing appliance comprising a tub having a wall member and defining an access opening, and a base member configured to receive the tub. Each of the base member and the wall member of the tub may include complementary engageable surfaces. The washing appliance further comprises an adhesive substance disposed between the complementary engageable surfaces so as to operably engage the tub with the base member. The adhesive substance may include, but is not limited to: epoxy adhesives; methacrylate adhesives; and combinations of such adhesive substances. Furthermore, according to various embodiments, the washing appliance may include, but is not limited to a dish washing machine and a laundry washing machine.

In some washing appliance embodiments, the adhesive substance may be disposed on a structural tape disposed between the complementary engageable surfaces so as to operably engage the tub with the base member. Furthermore, in some such embodiments, the adhesive substance may comprise a first adhesive material disposed on one side of the structural tape and a second adhesive material disposed on the opposite side of the structural tape, such that the structural tape is configured to be operably engaged between the complementary engageable surfaces.

In some embodiments, the base member includes a front portion and a rear portion, wherein the tub is operably engaged with the base member such that the access opening defined in the tub is disposed substantially adjacent to the front portion and wherein the complementary engageable surfaces and the adhesive substance disposed therebetween are disposed substantially adjacent to the rear portion of the base member.

According to some embodiments, the washing appliance may further comprise a support member (such as a support frame, for example) operably engaged with the tub about the access opening. In some such embodiments, a portion of the support member (such as a support leg) may extend outward from the tub to engage the base member. Furthermore, some such embodiments may further comprise a brace member operably engaged between the support member and the rear portion of the base member.

Other embodiments of the present invention may further provide a method of assembling a base member with a tub in a washing appliance, wherein the washing appliance may include, but is not limited to, a dish washing machine and a laundry washing machine. The tub includes a wall member and defines an access opening therein. In one embodiment, the method comprises securing together complementary engageable surfaces of the base member and the wall member with an adhesive substance disposed therebetween. According to various method embodiments, the adhesive substance may include, but is not limited to: epoxy adhesives; methacrylate adhesives; and/or combinations of such adhesive materials.

Some method embodiments may further comprise steps for applying the adhesive substance to a structural tape disposed between the complementary engageable surfaces so as to operably engage the tub with the base member. According to some such embodiments, the applying step may further comprise applying a first adhesive material to one side of the structural tape and applying a second adhesive material to the opposite side of the structural tape.

As described herein with respect to various washing appliance embodiments, the base member may include a front portion and a rear portion. According to such embodiments, the method may further comprise positioning the tub relative to the base member such that the access opening defined by the tub is disposed substantially adjacent to the front portion and such that the complementary engageable surfaces and the adhesive substance disposed therebetween are disposed substantially adjacent to the rear portion of the base member.

Some additional method embodiments may further comprise steps for engaging a support member with the tub about the access opening such that a portion of the support member extends outward from the tub. In such embodiments, the method may further comprise engaging the portion of the support member with the base member such that at least a portion of the tub is operably engaged with a corresponding portion of the base member. In addition, some method embodiments may further comprise engaging a brace member between the support member and a rear portion of the base member.

Thus, the various embodiments of the present invention provide advantages that may include, but are not limited to: providing washing appliance assembly that is structurally sound and substantially fluid-tight; and providing a washing appliance assembly including a base member and tub that are securely operably engaged with one another with relative ease and without the need for potentially leak-producing fastener apertures defined by the tub.

These and other advantages are provided by various embodiments of the present invention.

### BRIEF DESCRIPTION OF THE SEVERAL VIEWS OF THE DRAWINGS

Having thus described various embodiments of the invention in general terms, reference will now be made to the accompanying drawings, which are not necessarily drawn to scale, and wherein:

FIG. 1 is a perspective view of a base member portion of a washing appliance, according to one embodiment of the present invention, including an adhesive substance disposed on an engageable surface of a rear portion of the base member for operably engaging a tub;

FIG. 2 is a partially-exploded perspective view of a washing appliance, according to one embodiment of the present invention, including a base member disposed adjacent to a tub comprising a support member operably engaged therewith about the access opening;

FIG. 3 is a perspective view of a washing appliance, according to one embodiment of the present invention, including a tub operably engaged with a base member including a front portion and a rear portion, wherein the tub is operably engaged with the base member such that the access opening defined in the tub is disposed substantially adjacent to the front portion, and wherein the complementary engageable surfaces and the adhesive substance disposed therebetween are disposed substantially adjacent to the rear portion of the base member;

FIG. 4 is a cross-sectional view of an adhesive substance disposed on a structural tape disposed between the complementary engageable surfaces so as to operably engage the tub with the base member, according to one embodiment of the present invention; and

FIG. 5 is a perspective view of a washing appliance, according to one embodiment of the present invention, including a tub operably engaged with a base member including a front portion and a rear portion, wherein a brace member is operably engaged between a support member operably engaged about an access opening of the tub and a rear portion of the base member.

### DETAILED DESCRIPTION OF VARIOUS EMBODIMENTS OF THE INVENTION

Various embodiments of present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

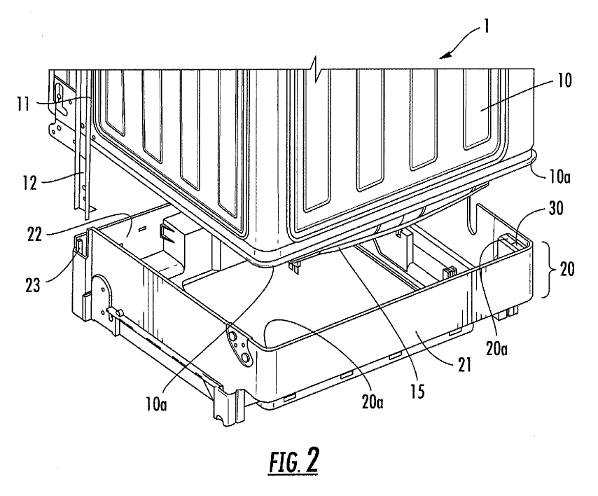

Although the various embodiments of the invention described herein are directed to an apparatus and method for assembling a dish washing machine, it will be appreciated by one skilled in the art that the invention is not so limited. For example, aspects of the washing appliance and method of the present invention can also be incorporated into other washing appliances (such as laundry washing machines, for example) including wash tubs that may be mounted to base members in order to form a substantially unitary and fluid-tight appliance structure. In one example, the apparatus embodiments of the present invention may be used to construct a “front load” laundry washing machine having a substantially fluid-tight outer tub operably engaged with a base member via one or more adhesive substances 30 so as to avoid forming fastener apertures in such an outer tub when assembling the appliance. According to such embodiments, one skilled in the art will appreciate that an agitator and/or rotatable inner drum may be rotatably engaged with drive shaft or other bearing assembly inserted through the outer tub in an aperture defined in a wall other than the wall member defining one or more of the engageable surfaces (10a, 20a, for example, as shown in FIG. 2) of the washing appliance 1.

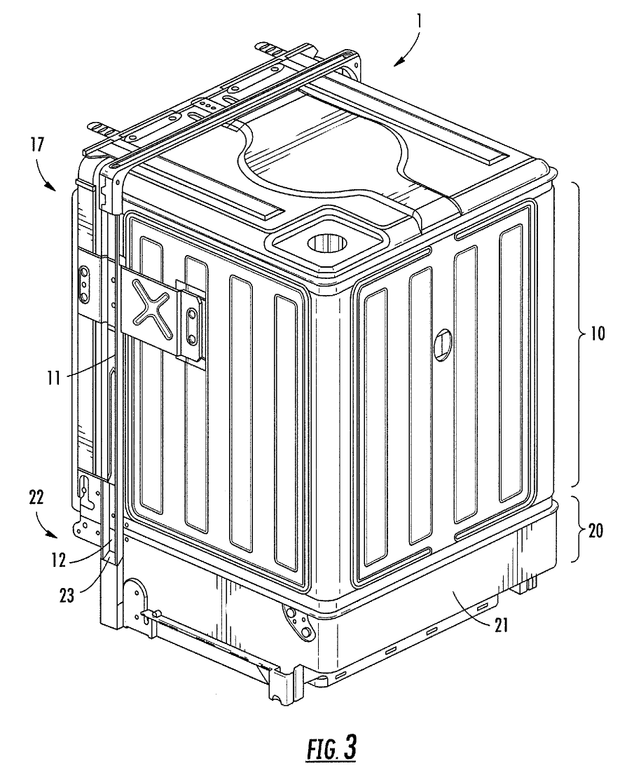

Referring to FIG. 3, one embodiment of the present invention provides a washing appliance 1 comprising a tub 10 having a wall member 15 (such as a floor and/or bottom wall member as shown in FIG. 2, for example). The tub 10 may also define an access opening 17 (such as a door opening, for example, for a dishwasher or laundry washing machine assembly). The washing appliance 1 further comprises a base member 20 configured to receive the tub 10, wherein the base member 20 and the wall member 15 of the tub 10 include complementary engageable surfaces 10a, 20a (see FIG. 2). The washing appliance 1 further comprises an adhesive substance 30 disposed between the complementary engageable surfaces 10a, 20a so as to operably engage the tub 10 with the base member 20. The use of the adhesive substance 30 disposed between the complementary engageable surfaces 10a, 20a allows the tub 10 and the base member 20 to be connected to form a substantially unitary washing appliance 1 assembly without the need for forming fastener apertures in the various wall members (such as the wall member 15, for example) of the tub 10. Thus, the portions of the tub 10 away from the access opening 17 may be capable of maintaining a substantially fluid-tight enclosure within the washing appliance 1.

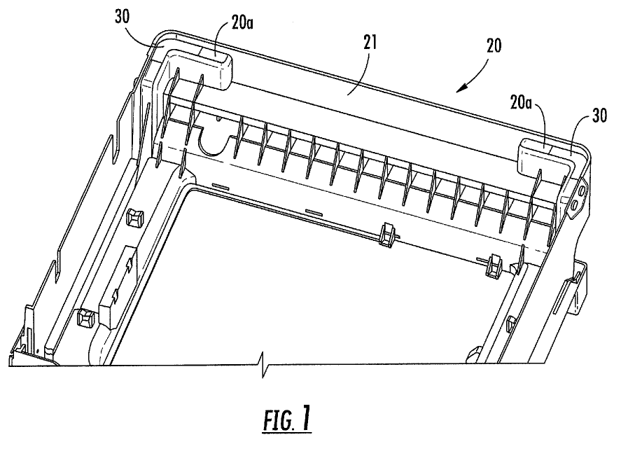

According to various washing appliance 1 embodiments, the tub 10 may comprise a variety of different metals, metallic alloys, polymers, and/or composite materials. For example, the tub 10 may be formed as a single integral workpiece including, but not limited to: a stamped metal (stainless steel, for example) tub; and a molded polymer tub. Furthermore, the base member 20 may, in some washing appliance 1 embodiments, be formed from a single piece and/or integral construction using materials that may include, but are not limited to: metals; metallic alloys; polymers; composite materials; and/or combinations of such materials. As shown generally in FIG. 2, the base member 20 may comprise one or more wall members connected (via adhesives, welds, and fasteners, including but not limited to rivets, screws, bolts, and/or combinations thereof) to form a base member 20 that is configured to be capable of supporting the tub 10 and/or a variety of additional components within the washing appliance 1 assembly (see FIG. 3, for example). In some embodiments, the base member 20 may define a substantially hollow central portion configured to be capable of supporting and/or being operably engaged with various components of the washing appliance 1 such as various controls, valves and pumps, for example. Thus, the structure of the base member 20 may not only support the tub 10, but also provide surfaces and/or mounting points for operably engaging the various components of the washing appliance 1, outside the tub 10 but within the overall structure of the washing appliance 1 (see FIG. 3, generally). As shown in FIGS. 1 and 2, the base member 20 may also define one or more engageable surfaces 20a upon which various wall members 15 (and complementary engageable surfaces 10a thereof) may be supported when assembling the washing appliance 1. Such surfaces 20a and/or mounting points may be integrally formed with the base member 20 (using a molding process and/or a stamping process, for example) and/or may be provided as separate support components (such as brackets and/or flanges, for example) that may be operably engaged with the base member 20 via one or more fasteners, welds, and/or adhesive substances.

As shown in FIGS. 1 and 2, the base member 20 may include a front portion 22 and a rear portion 21 (such as front and rear wall assemblies, for example). According to such embodiments, the tub 10 may be operably engaged with the base member 20 such that the access opening 17 defined in the tub 10 is disposed substantially adjacent to the front portion 22. Furthermore, in such embodiments, the complementary engageable surfaces 10a, 20a (and the adhesive substance 30 disposed therebetween) may be disposed substantially adjacent to the rear portion 21 of the base member 20. According to some embodiments, as shown generally in FIG. 2, the engageable surfaces 20a of the base member 20 may be oriented substantially parallel to a wall member 15 (such as a floor and/or bottom wall member as shown in FIG. 2, for example) such that a portion of the wall member 15 defining the engageable surface 10a of the tub 10 may rest on and/or be supported by the engageable surface 20a of the base member 20 when the washing appliance 1 is assembled (see FIG. 3, for example).

As shown in FIGS. 2 and 3, some washing appliance 1 embodiments may further comprise a support member 11 (such as a steel support frame, for example) operably engaged with the tub 10 about the access opening 17 for providing additional structural support to the washing appliance 1 about the access opening 17 (which may comprise a door access opening). Furthermore, as shown in FIG. 2, a portion 12 (such as a support leg, for example) of the support member 11 may extend outward from the tub 10 so as to operably engage the tub 10 with a portion of the base member 20 (such as a front portion 22 thereof). In some embodiments, the portion 12 of the support member 11 may extend outward from the tub 10 so as to operably engage the tub 10 with a portion of the base member 20 (such as a bracket or other attachment point disposed on an inner and/or outer surface of the base member 20. Furthermore, in other embodiments, as shown generally in FIG. 2, the base member 20 may define one or more support apertures 23 configured to receive the portion 12 of the support member 11 extending outward from the tub 10. In such embodiments, the insertion of the portion 12 of the support member 11 into the complementary support aperture 23 defined in the base member 20 (and/or a front portion 22 thereof) may provide an additional point of engagement between the tub 10 and base member 20 so as to augment the connection between the tub 10 and base member 20 (and/or the complementary engageable surfaces 10a, 20a thereof) provided by the adhesive substance 30 described further herein.

For example, in some embodiments wherein the support member 11 is operably engaged with the tub 10 about the access opening 17, the engagement of the portion 12 of the support member 11 with the base member 10 (via a bracket and/or a complementary support aperture 23) may provide a structural engagement point between the tub 10 and base member 20 such that the adhesive substance 30 need only be disposed between the complementary engageable surfaces 10a, 20a disposed substantially adjacent to the rear portion 21 of the base member 20 to form the washing appliance 1 assembly shown generally in FIG. 3. However, in some embodiments, it should be appreciated that the tub 10 and the base member 20 may be operably engaged with one another via an adhesive substance 30 that may also be disposed between complementary engageable surfaces disposed substantially adjacent to the front portion 22 of the base member 20.

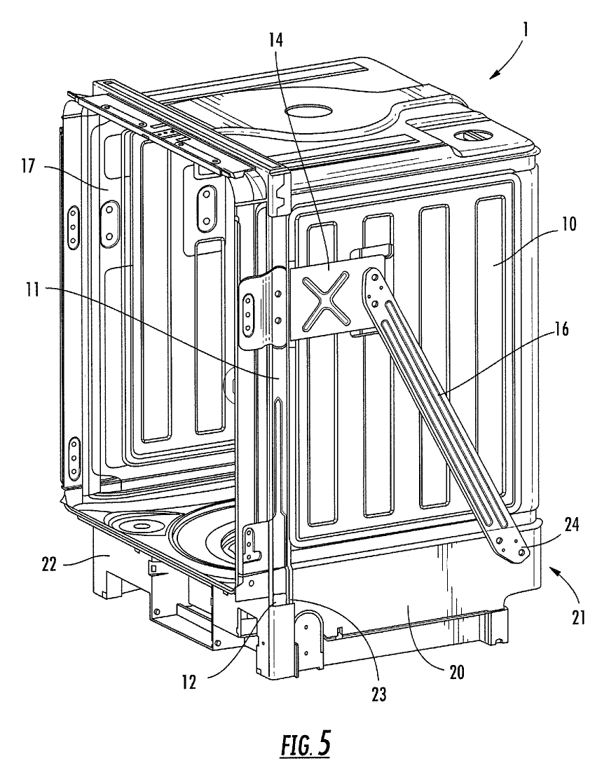

Furthermore, as shown in FIG. 5, in some embodiments wherein the support member 11 is operably engaged with the tub 10 about the access opening 17, an additional brace member 16 may be operably engaged between the support member 11 and a rear portion 21 of the base member 20 so as to further augment the connection between the tub 10 and base member 20 (and/or the complementary engageable surfaces 10a, 20a thereof) provided by the adhesive substance 30 described further herein. It should also be understood that the brace member 16 may also lend additional structural rigidity and/or structural support to the washing appliance 1. In some embodiments, a bracket 14 may extend rearward from the access opening 17 (and, more particularly, from the support member 11 operably engaged about the access opening 17). In some such embodiments, the bracket 14 may be operably engaged with the tub 10 via one or more apertures or other mounting points disposed substantially adjacent to the access opening 17 that may be configured to serve as attachment points for rollers, slider devices, and/or other load-bearing devices configured to support a dish tray, dish rack, or other support structure that may be slidably disposed on the interior of the tub 10.

Furthermore, in some embodiments, the brace member 16 may be operably engaged with at least one of the support member 11 and the tub 10 via at least one aperture defined in the tub 10 substantially adjacent to the access opening 17, wherein the at least one aperture may be pre-defined in the tub 11 and adapted to receive a fastener for supporting at least one component (including but not limited to a dish tray, dish rack, sensor, washing arm, roller device, and/or slider device) disposed substantially inside the tub 11. Because such pre-defined apertures (such as those shown in FIG. 5) for operably engaging the bracket 14 with the tub 11 may be advantageously positioned near a top portion of the tub 11 and substantially above a level of standing water that may be present inside the tub 11 during the operation of the washing appliance 1, the risk of leakage from the tub 11 is reduced.

As shown in FIG. 5, the brace member 16 may thus, in such embodiments, be operably engaged in a substantially diagonal configuration between the bracket 14 and the rear portion 21 of the base member 20. In some embodiments, the brace member 16 may serve to provide additional rigidity and/or structural support to the washing appliance 1. Furthermore, in some embodiments, at least one of the support members 11, the brace member 16 and the bracket 14 may serve as a “lifting point” whereby a gripping implement, forklift, or other lifting implement may temporarily operably engage the washing appliance 1 for lifting, installation, and or transport. Such “lifting points” provided by the support member 11, the brace member 16 and/or bracket 14 may be especially useful in embodiments wherein the tub 10 comprises a stamped stainless steel and/or substantially flexible polymer tub that may be easily damaged by the application of a lifting and/or gripping force. In other instances, the support member 11, the brace member 16 and/or bracket 14 may be configured to cooperate to provide structural rigidity for the washing appliance 1, particularly when the gripping force involves laterally spaced gripping arms which are urged toward each other so as to grip the sides of the washing appliance 1.

Furthermore, as shown in FIG. 5, the rear portion 21 of the base member 20 (and/or a side wall of the base member 20 substantially adjacent to the rear portion 21) may define one or more apertures 24 configured to receive fasteners for operably engaging the brace member 16 with the base member 20 of the washing appliance 1. Thus, the engagement of the additional brace member 16 between the support member 11 and the base member 20 may add structural rigidity and/or enhanced support to the washing appliance 1 without the need for forming fastener apertures in the tub 10.

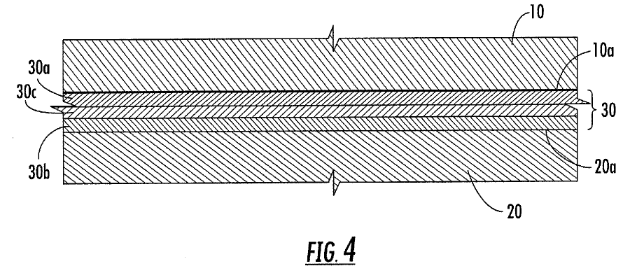

According to various washing appliance 1 embodiments, the adhesive substance 30 disposed between the complementary engageable surfaces 10a, 20a of the tub 10 and base member 20 may comprise a variety of adhesive substances that may include, but are not limited to: epoxy adhesives; methacrylate adhesives; and combinations of such adhesive types. Furthermore, in some embodiments as shown in FIG. 4, the adhesive substance 30 may be disposed on a structural tape 30c disposed between the complementary engageable surfaces 10a, 20a so as to operably engage the tub 10 with the base member 20. According to some such embodiments, the adhesive substance 30 may comprise a first adhesive material 30a disposed on one side of the structural tape 30c and a second adhesive material 30b disposed on the opposite side of the structural tape 30c. As shown in FIG. 4, the first adhesive material 30a may be configured to adhere substantially to the tub 10, and the second adhesive material 30b may be configured to adhere substantially to the base member 20 such that the structural tape 30c is operably engaged between the complementary engageable surfaces 10a, 20a of the tub 10 and base member 20 in order to form a washing appliance 1 assembly as shown, for example, in FIG. 3. Thus, according to various embodiments, the structural tape 30c may serve as a base material on which a variety of adhesive substances may be disposed that are selected to adhere substantially to a variety of materials that may be used to form and/or construct the tub 10 and/or base member 20 components of the washing appliance 1.

As shown generally in FIG. 2, various embodiments of the present invention also provide methods for assembling a base member 20 with a tub 10 in a washing appliance 1. As described herein, the tub 10 may have a wall member 15 (such as a floor member, for example) and may further define an access opening 17 (such as a door opening, for example). In some embodiments, the method comprises securing together complementary engageable surfaces 10a, 20a of the base member 20 and the wall member 15 of the tub 10 with an adhesive substance 30 disposed therebetween. According to various method embodiments, the adhesive substance 30 utilized in the securing step may comprise a variety of different adhesive materials suitable for adhering the tub 10 to the base member 20 (and/or to one or more pieces of structural tape 30c (see FIG. 4, for example) disposed therebetween. For example, the adhesive material 30 may include, but is not limited to: epoxy adhesives; methacrylate adhesives; and combinations of such adhesive materials.

As described herein with respect to the various washing appliance 1 embodiments, the method embodiments may be used to assemble a base member 20 with a tub 10 in a variety of different washing appliances where it is preferable to minimize and/or eliminate potentially leak-producing fastener apertures in the various wall members 15 of the tub 10 such that the tub is substantially fluid tight when the washing appliance 1 is in operation. Therefore it should be understood that the various method embodiments of the present invention may be used to assemble a base member 20 with a tub 10 in washing appliances that may include, but are not limited to: dish washing machines; and laundry washing machines.

Furthermore, as shown in FIG. 2, in some embodiments the base member 20 may include a front portion 22 (that is generally accessible to a user, for example) and a rear portion 21 (that may be disposed adjacent a room wall or cabinet when the washing appliance is installed, for example). In such embodiments, the method may further comprise positioning the tub 10 relative to the base member 20 such that the access opening 17 defined in the tub 10 is disposed substantially adjacent to the front portion 22 (such that a user is capable of accessing a washing reservoir defined in the tub 10, for example) and such that the complementary engageable surfaces 10a, 20a and the adhesive substance 30 disposed therebetween are disposed substantially adjacent to the rear portion 21 of the base member 20.

Some method embodiments, as shown generally in FIG. 2, further comprise engaging a support member 11 (such as a steel frame, for example) with the tub 10 about the access opening 17 such that a portion 12 (such as a support leg, for example) of the support member 11 extends outward from the tub 10. Such embodiments may further comprise forming a complementary support aperture 23 in the base member 20 that may be configured and/or shaped to receive the portion 12 of the support member 11. Furthermore, such method embodiments may further comprise engaging the portion 12 of the support member 11 with the support aperture 23 and/or the base member 20 such that at least a portion of the tub 10 is operably engaged with a corresponding portion of the base member 20 (as shown generally in FIG. 3). As described herein with respect to FIG. 5, such method embodiments may further comprise engaging a brace member 16 between the support member 11 and a rear portion 21 of the base member 20.

Furthermore, as shown in FIG. 4, in some method embodiments, the step for securing together complementary engageable surfaces 10a, 20a of the base member 20 and the wall member 15 of the tub 10 may be accomplished by applying the adhesive substance 30 to a structural tape 30c disposed between the complementary engageable surfaces 10a, 20a so as to operably engage the tub 10 with the base member 20. According to some such method embodiments, the applying step may further comprise applying a first adhesive material 30a to one side of the structural tape 30c and applying a second adhesive material 30b to the opposite side of the structural tape 30c. As described herein with respect to FIG. 4, the first adhesive material 30a may be configured to adhere substantially to the tub 10 and the second adhesive material 30b may be configured to adhere substantially to the base member 20 for engaging the structural tape 30c between the complementary engageable surfaces 10a, 20a of the tub 10 and the base member 20, respectively.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A washing appliance comprising:
a tub having a wall member and defining an access opening;
a base member configured to receive the tub, wherein the base member and the wall member of the tub include complementary engageable surfaces; and
an adhesive substance disposed between the complementary engageable surfaces so as to operably engage the tub with the base member.

2. A washing appliance according to claim 1, further comprising a support member operably engaged with the tub about the access opening, a portion of the support member extending outward from the tub to engage the base member.

3. A washing appliance according to claim 1, wherein the base member includes a front portion and a rear portion and wherein the tub is operably engaged therewith such that the access opening defined in the tub is disposed substantially adjacent to the front portion and wherein the complementary engageable surfaces and the adhesive substance disposed therebetween are disposed substantially adjacent to the rear portion of the base member.

4. A washing appliance according to claim 3, further comprising a brace member operably engaged between the support member and the rear portion of the base member.

5. A washing appliance according to claim 4, wherein the brace member is operably engaged with at least one of the support member and the tub, via at least one aperture defined by the tub substantially adjacent to the access opening, the at least one aperture being adapted to receive a fastener for supporting at least one component substantially inside the tub.

6. A washing appliance according to claim 1, wherein the adhesive substance is associated with a structural tape disposed between the complementary engageable surfaces so as to operably engage the tub with the base member.

7. A washing appliance according to claim 6, wherein the adhesive substance further comprises a first adhesive material disposed on one side of the structural tape and a second adhesive material disposed on the opposite side of the structural tape, the structural tape being configured to be operably engaged between the complementary engageable surfaces.

8. A washing appliance according to claim 1, wherein the adhesive substance is selected from the group consisting of:
epoxy adhesives;
methacrylate adhesives; and
combinations thereof.

9. A washing appliance according to claim 1, wherein the washing appliance comprises one of a dish washing machine and a laundry washing machine.

10. A method of assembling a base member with a tub in a washing appliance, the tub having a wall member and defining an access opening, the method comprising securing together complementary engageable surfaces of the base member and the wall member with an adhesive substance disposed therebetween.

11. A method according to claim 10, wherein the base member includes a front portion and a rear portion, the method further comprising positioning the tub relative to the base member such that the access opening defined by the tub is disposed substantially adjacent to the front portion and such that the complementary engageable surfaces and the adhesive substance disposed therebetween are disposed substantially adjacent to the rear portion of the base member.

12. A method according to claim 10, further comprising:
engaging a support member with the tub about the access opening such that a portion of the support member extends outward from the tub; and
engaging the portion of the support member with the base member such that at least a portion of the tub is operably engaged with a corresponding portion of the base member.

13. A method according to claim 12, further comprising engaging a brace member between the support member and a rear portion of the base member.

14. A method according to claim 10, further comprising applying the adhesive substance to a structural tape disposed between the complementary engageable surfaces so as to operably engage the tub with the base member.

15. A method according to claim 14, wherein the applying step further comprises:
applying a first adhesive material to one side of the structural tape; and
applying a second adhesive material to the opposite side of the structural tape, the structural tape thereby being configured to be operably engaged between the complementary engageable surfaces of the tub and the base member.
